(19) United States
(12) Patent Application Publication
(10) Pub. No.: US 2018/0143662 A1
(43) Pub. Date: May 24, 2018

(54) ATTACHMENT FOR DEVICES

(71) Applicant: Intel Corporation, Santa Clara, CA (US)

(72) Inventors: Ralph V. Miele, Hillsboro, OR (US); Amin Mohammed Godil, Beaverton, OR (US); Andrew Larson, Hillsboro, OR (US); Shantanu D. Kulkarni, Hillsboro, OR (US); Dan H. Gerbus, Aloha, OR (US); Andrew C. Dausman, Lake Oswego, OR (US); David A. Rittenhouse, Fair Oaks, CA (US)

(73) Assignee: Intel Corporation, Santa Clara, CA (US)

(21) Appl. No.: 15/577,214

(22) PCT Filed: Jun. 27, 2015
(86) PCT No.: PCT/US15/38195

§ 371 Date: Nov. 27, 2017

(51) Int. Cl. G06F 1/16

(52) U.S. Cl. CPC G06F 1/16; H04N 13/0203

(57) ABSTRACT

Particular embodiments described herein provide for an electronic device, such as a notebook computer or laptop, that includes a circuit board coupled to a plurality of electronic components (which includes any type of components, elements, circuitry, etc.). The electronic device may also include a first housing and a structurally sensitive module. The structurally sensitive module can include a structurally sensitive component and a structurally sensitive attachment. The structurally sensitive attachment includes one or more mounting tabs to structurally isolate the structurally sensitive component from the first housing.

### TECHNICAL FIELD

Embodiments described herein generally relate to hinge configurations for an electronic device.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified schematic diagram illustrating a plan view of an embodiment of an attachment for devices, in accordance with one embodiment of the present disclosure;

FIG. 2 is a simplified schematic diagram illustrating an orthographic view of an embodiment of an attachment for devices, in accordance with one embodiment of the present disclosure;

FIG. 3 is a simplified schematic diagram illustrating an orthographic view of an embodiment of an attachment for devices, in accordance with one embodiment of the present disclosure;

FIG. 4A is a simplified schematic diagram illustrating a cutaway side view of an embodiment of an attachment for devices, in accordance with one embodiment of the present disclosure;

FIG. 4B is a simplified schematic diagram illustrating a cutaway side view of an embodiment of an attachment for devices, in accordance with one embodiment of the present disclosure;

FIG. 5 is a simplified schematic diagram illustrating an exploded orthographic view of an embodiment of an attachment for devices, in accordance with one embodiment of the present disclosure;

FIG. 6 is a simplified schematic diagram illustrating an exploded plan view of an embodiment of an attachment for devices, in accordance with one embodiment of the present disclosure;

FIG. 7 is a simplified schematic diagram illustrating a plan side view of an embodiment of an attachment for devices, in accordance with one embodiment of the present disclosure;

FIG. 8 is a simplified schematic diagram illustrating a plan cutaway view of an embodiment of an attachment for devices, in accordance with one embodiment of the present disclosure;

FIG. 9 is a simplified schematic diagram illustrating a plan cutaway view of an embodiment of an attachment for devices, in accordance with one embodiment of the present disclosure;

FIG. 10 is a simplified schematic diagram illustrating an orthographic view of an embodiment of an attachment for devices, in accordance with one embodiment of the present disclosure;

FIG. 11 is a simplified schematic diagram illustrating a plan side view of an embodiment of an attachment for devices, in accordance with one embodiment of the present disclosure;

FIG. 12 is a simplified schematic diagram illustrating an orthographic view of an embodiment of an attachment for devices, in accordance with one embodiment of the present disclosure;

FIG. 13 is a simplified schematic diagram illustrating an exploded orthographic view of an embodiment of an attachment for devices, in accordance with one embodiment of the present disclosure;

FIG. 14 is a simplified schematic diagram illustrating a side view of an embodiment of an attachment for devices, in accordance with one embodiment of the present disclosure;

FIG. 15 is a block diagram illustrating an example computing system that is arranged in a point-to-point configuration in accordance with an embodiment;

FIG. 16 is a simplified block diagram associated with an example ARM ecosystem system on chip (SOC) of the present disclosure; and

FIG. 17 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

The following detailed description sets forth example embodiments of apparatuses, methods, and systems relating to hinge configurations for an electronic device. Features such as structure(s), function(s), and/or characteristic(s), for example, are described with reference to one embodiment as a matter of convenience; various embodiments may be implemented with any suitable one or more of the described features.

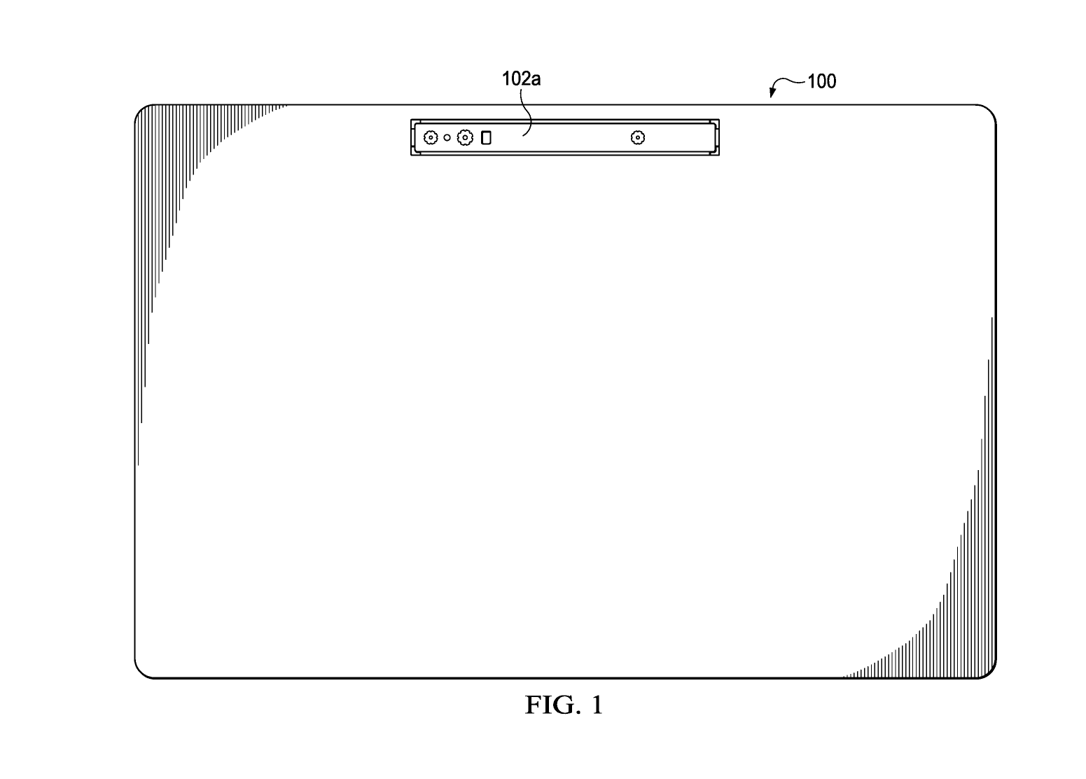

FIG. 1 is a simplified block diagram of an electronic device 100 that includes an structurally sensitive module 102a. Attachment for device 102a can be configured to prevent or minimize deformation of a structurally sensitive component mounted on structurally sensitive module 102a when external loads are applied on electronic device 100. The deformation of the structurally sensitive component could cause the structurally sensitive component to quit functioning or lose calibration. For example, if a three dimensional (3D) camera were mounted on attachment device 102a, attachment device 102a can at least partially isolate the 3D camera from electronic device 100 so deflection, or minimal deflection of electronic device 100 does not transfer to the 3D camera.

The foregoing is offered by way of non-limiting examples in which the system and method of the present specification may usefully be deployed. The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiment many have different advantages, and no particular advantage is necessarily required of any embodiment.

For purposes of illustrating certain example techniques of structurally sensitive module 102a, it is important to understand the foundational information related to attachment for electronic device 102a. The following foundational information may be viewed as a basis from which the present disclosure may be properly explained.

The advent and proliferation of 3D cameras has introduced a system level structural integration challenge. Often the camera design requires extremely accurate in plane alignment of the infra-red (IR) sensors during camera operation. Physical attachment of 3D cameras of this type to an electronic device (e.g. electronic device 100) can cause structural coupling between the camera and the system. This structural coupling often causes deflection of the structurally sensitive camera when loads (i.e. user handling) are applied to the external housing of the 3D camera.

In general, structurally sensitive components can experience the same deflection of the structure on which the sensitive component is mounted. Deflection of structurally sensitive components, such as the 3D camera, can cause performance to degrade or the device may stop functioning. To avoid this scenario, the 3D camera, or structurally sensitive device, must be structurally decoupled when it is physically attached to the structure. In order to achieve this, the structurally sensitive component must be constrained to the structure in such a way that when external forces are applied on the structure, bending and twisting of the structurally sensitive component is minimal. The problem is further complicated by the general drive to provide thinner low profile form factors which do not allow much space for mechanical fastening. What is needed is a system and method to structurally decouple structurally sensitive components (e.g., 3D camera) from the rest of the system so that external loads do not affect the function of the structurally sensitive components. It would be beneficial is the system and method would enable a low profile device height.

An attachment for devices, as outlined in FIG. 1, can resolve these issues (and others). Structurally sensitive module 102a may be configured to allow for the placement of compliant material above, below, or above and below mounting tabs of structurally sensitive module 102a. In addition, the mounting tabs can be placed close together to eliminate or minimize the torque coupling between the component and the system and the mounting tabs can be placed near the center of structurally sensitive module 102a to allow equal clearance on each side of structurally sensitive components from the cover or other components

Structurally sensitive module 102a can be configured such that there is compliancy either in the mounting tabs of a structurally sensitive component or in the fastening mechanism for the structurally sensitive component to electronic device 100. This can allow compliancy between the structurally sensitive component and electronic device 100 that allows for relative motion between the structurally sensitive component and electronic device 100.

Structurally sensitive module 102a may be configured to allow for relative motion between the structurally sensitive component and electronic device 100 with a minimal amount of load application to the structurally sensitive component such as a 3D camera or similar device. Fastening locations of structurally sensitive module 102a may be as close together as possible in order to minimize or eliminate torsion between the camera and the system. Alternatively, one mounting location can be used, but there should be a means by which to prevent the device from rotating. In an example, of a single mounting hole can be used to eliminate or reduce torque coupling. In another example, the mounting holes can be located as close to the center as possible to allow even clearance between the structurally sensitive component and electronic device 100. This can allow for relative motion between electronic device 100 and the structurally sensitive component without interference or with very little interference.

Particular embodiments described herein provide for an electronic device (e.g., electronic device 100), such as a notebook computer, laptop, cellphone, or other mobile device that includes a circuit board coupled to a plurality of electronic components (which includes any type of components, elements, circuitry, etc.). Note that any number of connectors (e.g., Universal Serial Bus (USB) connectors (e.g., in compliance with the USB 3.0 Specification), Thunderbolt™ connectors, WiFi connectors, a non-standard connection point such as a docking connector, etc.) and a plurality of antennas can be provisioned in conjunction with electronic device 100. [Thunderbolt™ and the Thunderbolt logo are trademarks of Intel Corporation in the U.S. and/or other countries.] The antennas are reflective of electrical components that can convert electric currents into radio waves. In particular examples, the antennas can be associated with WiFi activities, wireless connections more generally, small cell deployments, Bluetooth, 802.11, etc.

In regards to the internal structure associated with electronic device 100, electronic device 100 can include memory elements for storing information to be used in the operations outlined herein. Electronic device 100 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in electronic device 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, electronic device 100 may include software modules to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, electronic device 100 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’ Electronic device 100 can be an electronic element and includes, for example, desktop computers, laptop computers, mobile devices, personal digital assistants, smartphones, tablets, or other similar devices.

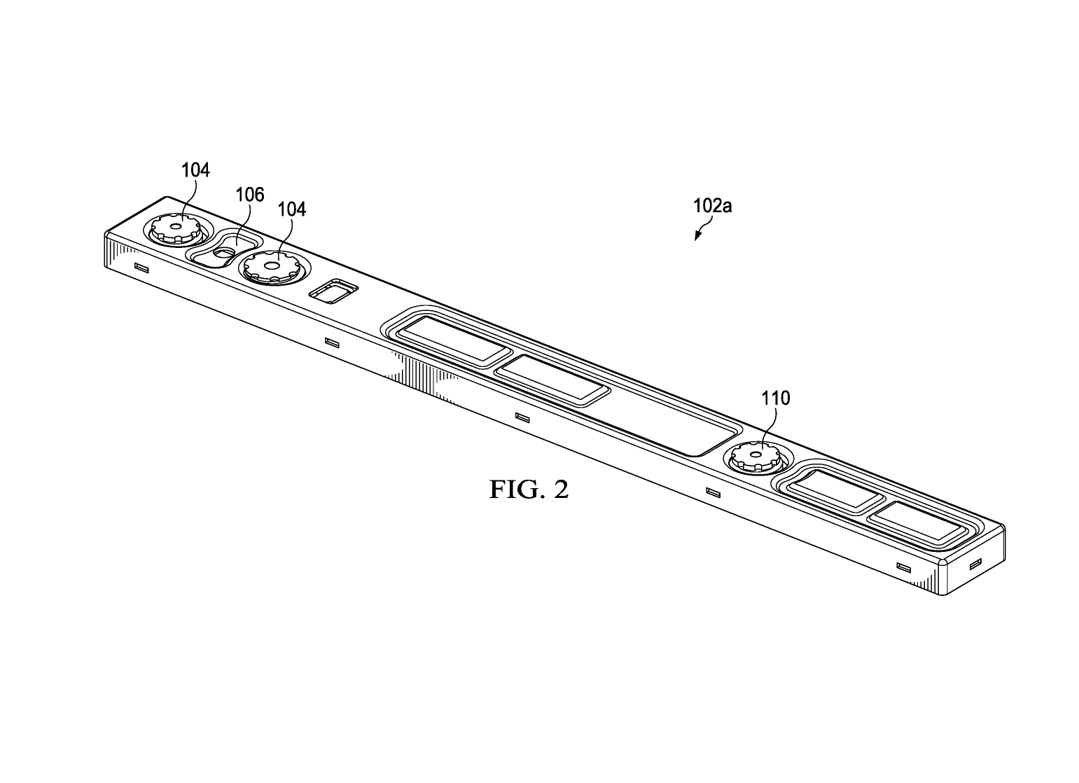

Turning to FIG. 2, FIG. 2 is a simplified schematic diagram illustrating a simplified orthographic view of an embodiment of structurally sensitive module 102a, in accordance with one embodiment of the present disclosure. As illustrated in FIG. 2, a 3D camera is included in structurally sensitive module 102a. The 3D camera can include 3D lenses 104, IR sensor 106, and red green blue camera (RGB) camera 110.

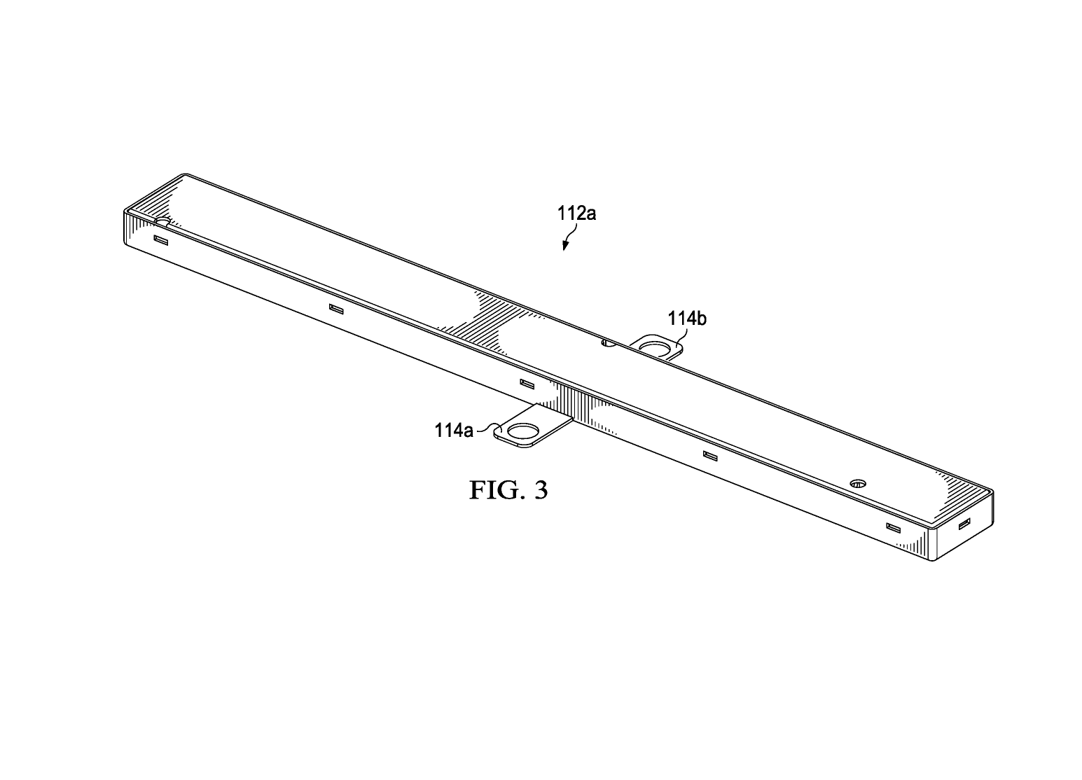

Turning to FIG. 3, FIG. 3 is a simplified schematic diagram illustrating a simplified orthographic view of a portion of an embodiment of structurally sensitive module 102a, in accordance with one embodiment of the present disclosure. Fastener 122 can be configured to structurally isolate sensitive module 102a from chassis 120 of electronic device 100. In an example, mounting tabs 114a and 114b can be configured to allow for relative motion between a mounted structurally sensitive component and electronic device 100.

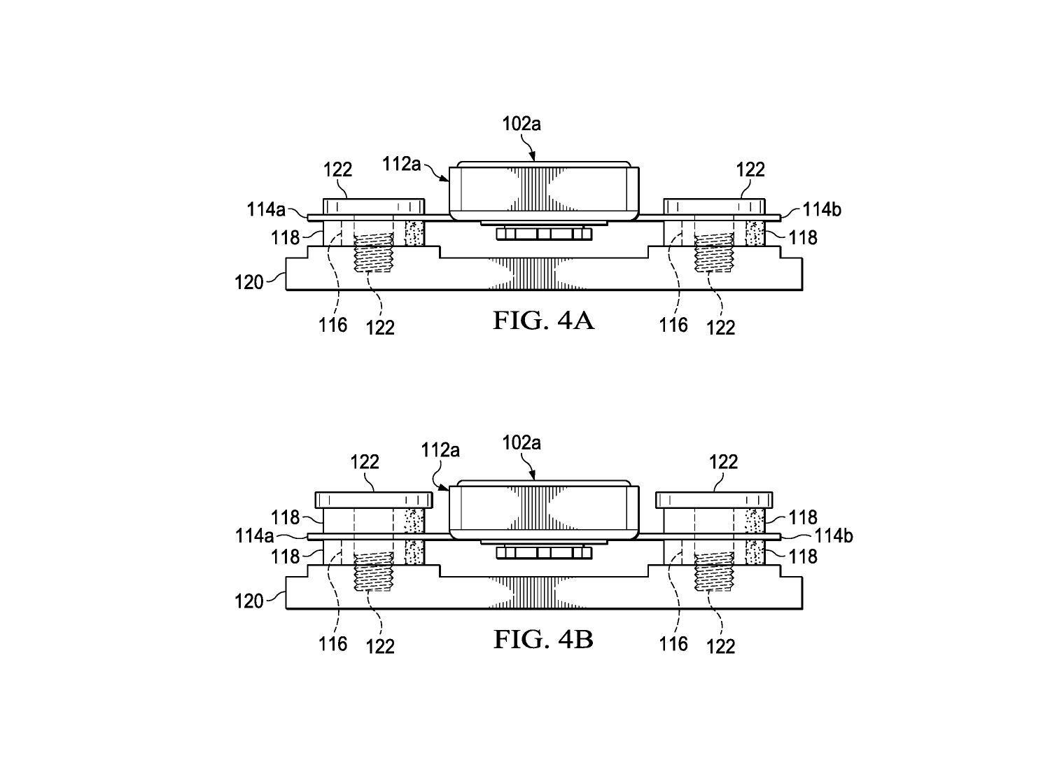

Turning to FIG. 4A, FIG. 4A is a simplified cutaway side view illustrating of an embodiment of structurally sensitive module 102a, in accordance with one embodiment of the present disclosure. Structurally sensitive module 102a can include an attachment for devices 112a and mounting tabs 114a and 114b. Each mounting tab 114a and 114b can be secured to chassis 120 of electronic device 100 using a boss 116, a washer 118, and a fastener 122. Using mounting tabs 114a and 114b, boss 116, washer 118, and fastener 122, structurally sensitive module 102a can be structurally isolated from chassis 120 of electronic device 100.

Mounting tabs 114a and 114b can be configured to act as cantilevered beams and provide isolation for structurally sensitive module 102a from electronic device 100. Fastener 122 may be a screw or some other similar type of fastener that can secure attachment for devices 112a to chassis 120. Washer 118 may include a rubberized or other force absorbing material to provide isolation for structurally sensitive module 102a from electronic device 100. In an example, the hole in mounting tabs 114a and 114b is bigger than the size of the boss 116 so mounting tabs 114a and 114b are sandwiched between fastener 122 and washer 118. In another example, fastener 122 can bottom out on top of washer 118 inside boss 116 such that mountings tabs 114a and 114b float on top of washer 118 and is not pinched on top of washer 118. This allows decoupling of attachment for devices 112a from chassis 120.

Turning to FIG. 4B, FIG. 4B is a simplified cutaway side view illustrating of an embodiment of structurally sensitive module 102a, in accordance with one embodiment of the present disclosure. As illustrated in FIG. 4B, each mounting tab 114a and 114b can be secured to chassis 120 of electronic device 100 using a boss 116, two washers 118, and a fastener 122.

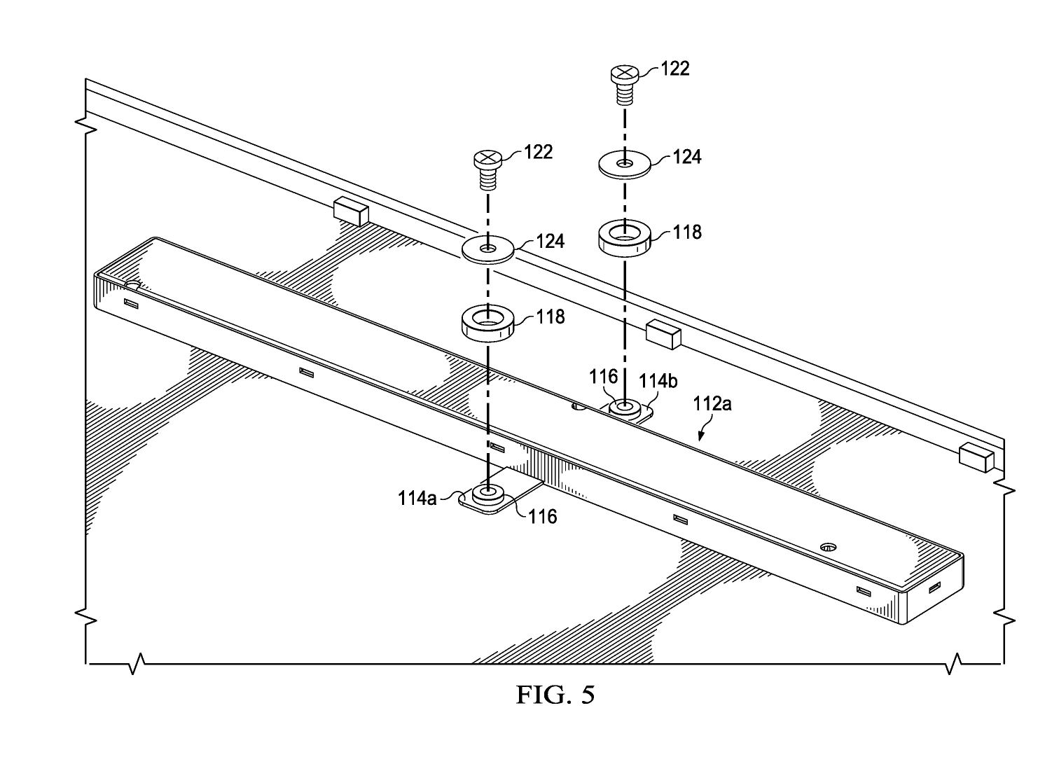

Turning to FIG. 5, FIG. 5 is a simplified exploded orthographic view illustrating of an embodiment of decoupling of attachment for devices 112a, in accordance with one embodiment of the present disclosure. As illustrated in FIG. 5, each mounting tab 114a and 114b can include boss 116. Washer 118 can be inserted over boss 116 and fastener 122 can secure decoupling of attachment for devices 112a to chassis 120 (not shown). In an example, a washer fastener 124 can help distribute the downward force from the head of fastener 122.

Turning to FIG. 6, FIG. 6 is a simplified exploded plan view illustrating an embodiment of decoupling of attachment for devices 112a, in accordance with one embodiment of the present disclosure. As illustrated in FIG. 6, decoupling of attachment for devices 112a may be mounted to an LCD panel 120 using male studs 132 and nuts 136. In an example, a thermal insulating solution 130 can act as a heat spreader and thermally isolate decoupling of attachment for devices 112a from LCD panel 120.

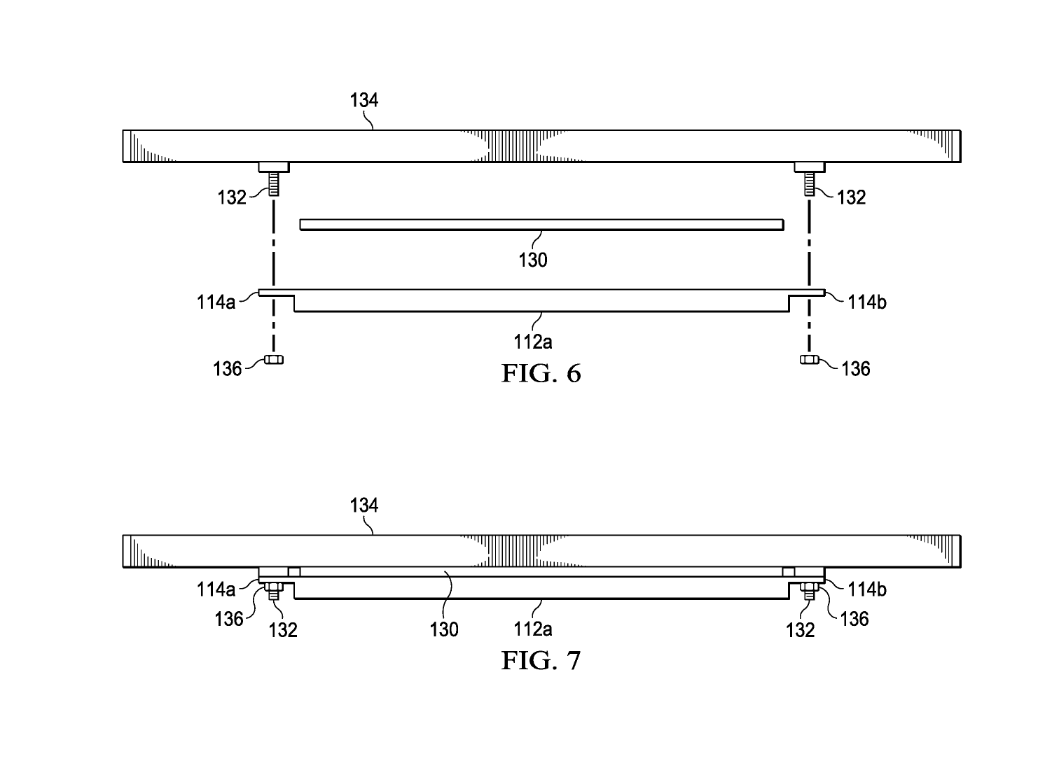

Turning to FIG. 7, FIG. 7 is a simplified exploded plan view illustrating an embodiment of decoupling of attachment for devices 112a, in accordance with one embodiment of the present disclosure. Male studs 132 can help provide camera alignment when a 3D camera is coupled to decoupling of attachment for devices 112a. Because LCD panel 120 has a relatively high stiffness, LCD panel 120 can help mitigate bending of a structurally sensitive device (e.g., a 3D camera) coupled to decoupling of attachment for devices 112a.

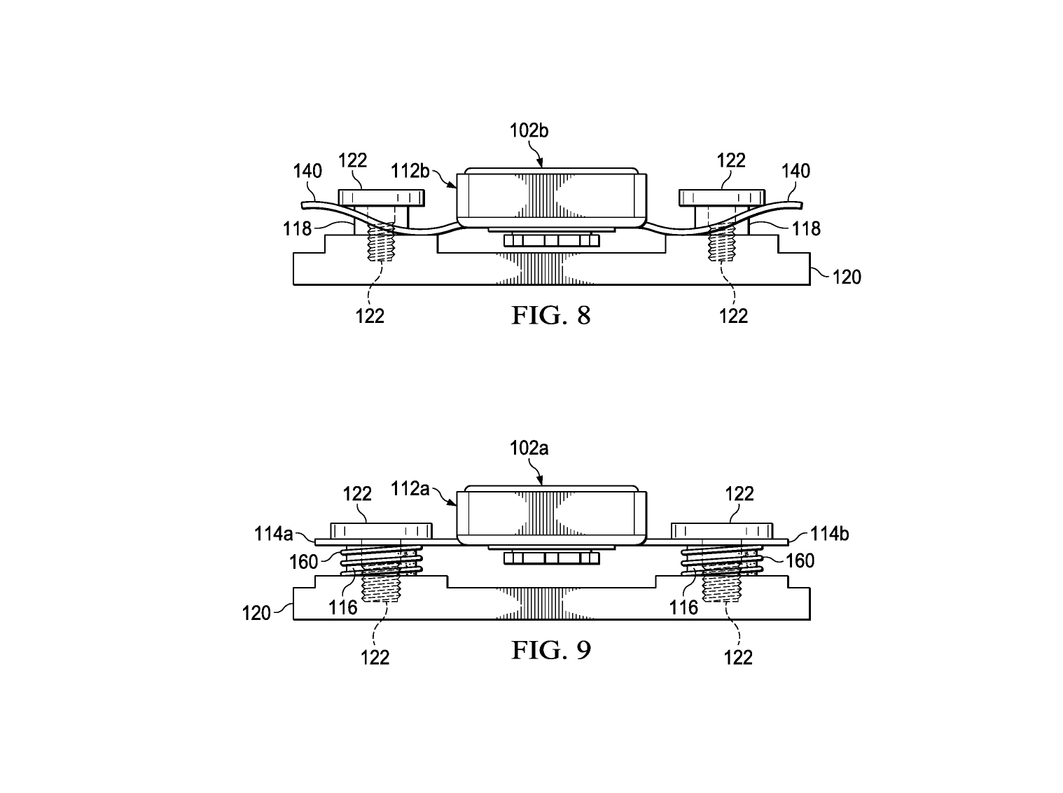

Turning to FIG. 8, FIG. 8 is a simplified cutaway side view illustrating of an embodiment of structurally sensitive module 102b, in accordance with one embodiment of the present disclosure. Structurally sensitive module 102b can include an attachment for devices 112b and cantilever mounting tabs 140. Each cantilever mounting tabs 140 can be secured to chassis 120 of electronic device 100 using washer 118 and fastener 122. Cantilever mounting tabs 140 can be configured to act as a cantilever spring to allow decoupling of attachment for devices 112a from chassis 120.

Turning to FIG. 9, FIG. 9 is a simplified cutaway side view illustrating of an embodiment of structurally sensitive module 102a, in accordance with one embodiment of the present disclosure. Using mounting tabs 114a and 114b, boss 116, fastener 122, and spring 160, structurally sensitive module 102a can be structurally isolated from chassis 120 of electronic device 100. Spring 160 can be configured to help provide force isolation for structurally sensitive module 102a from electronic device 100.

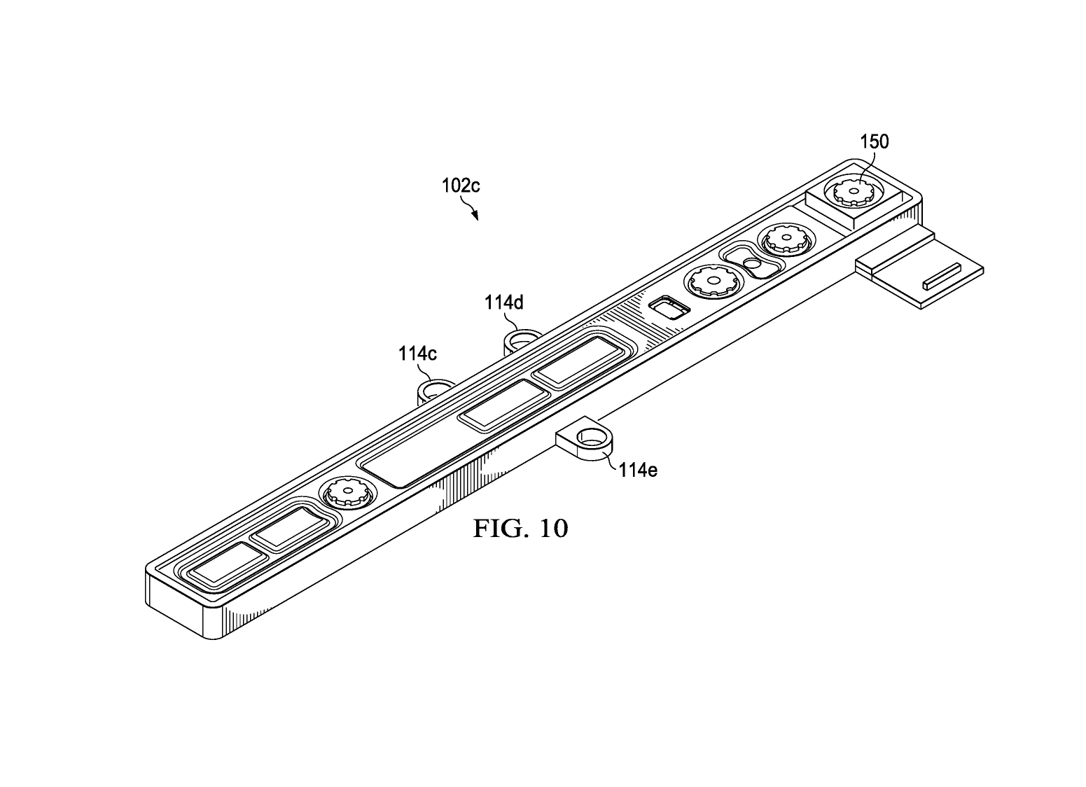

Turning to FIG. 10, FIG. 10 is a simplified orthographic view illustrating of an embodiment of structurally sensitive module 102c, in accordance with one embodiment of the present disclosure. Structurally sensitive module 102c can include an attachment for devices 112c. Attachment for devices 112c can include three mounting tabs 114c-114e. FIG. 10 illustrates that various modifications and changes may be made to attachment for devices 112a-112c including, but not limited to, the number and placement of mounting tabs 114a-114e while still providing structurally isolation of sensitive module 102a from electronic device 100.

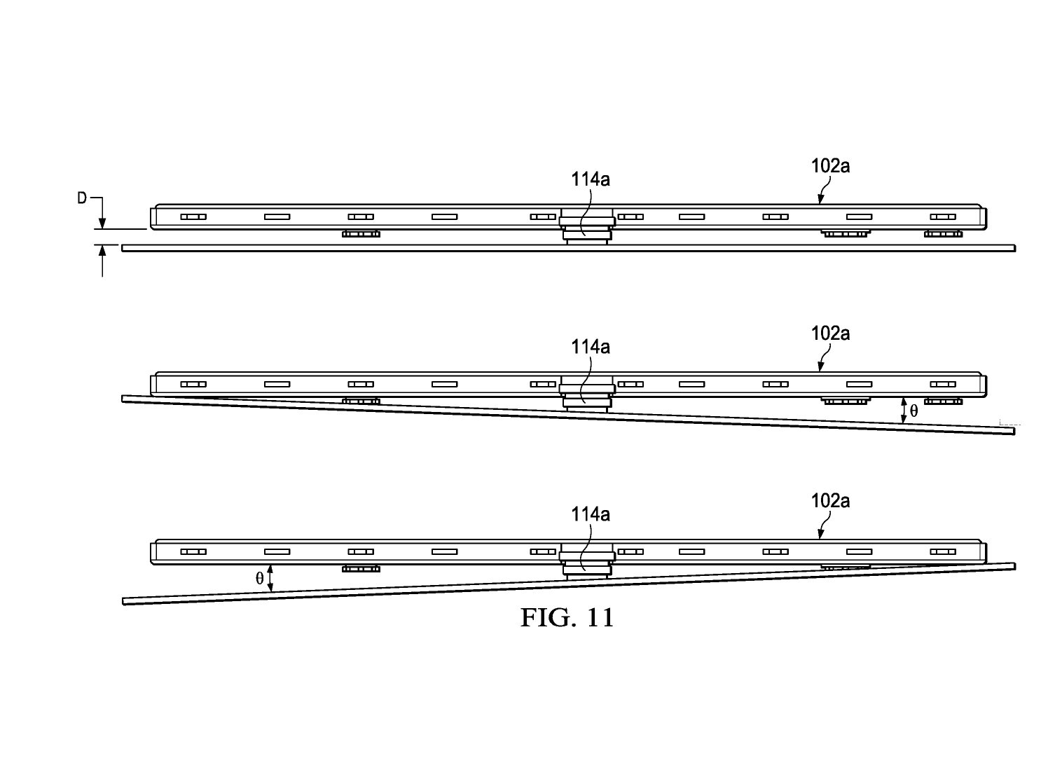

Turning to FIG. 11, FIG. 11 is a simplified orthographic view illustrating of an embodiment of structurally sensitive module 102a, in accordance with one embodiment of the present disclosure. When structurally sensitive module 102a is coupled to electronic device 100, a distance D can be created using the mounting tabs (e.g., mounting tab 114a) and the mounting assembly (e.g., illustrated in FIGS. 4A, 4B, 8, 9, etc). The distance D can allow for structurally sensitive module 102a to deflect a certain amount of degrees in each direction. The greater the distance D, the greater the angle of deflection that can be achieved by structurally sensitive module 102a for structurally isolation of sensitive module 102a from electronic device 100. In an example, mounting tab 114a may be located at an approximate center area 156 of structurally sensitive module 102a.

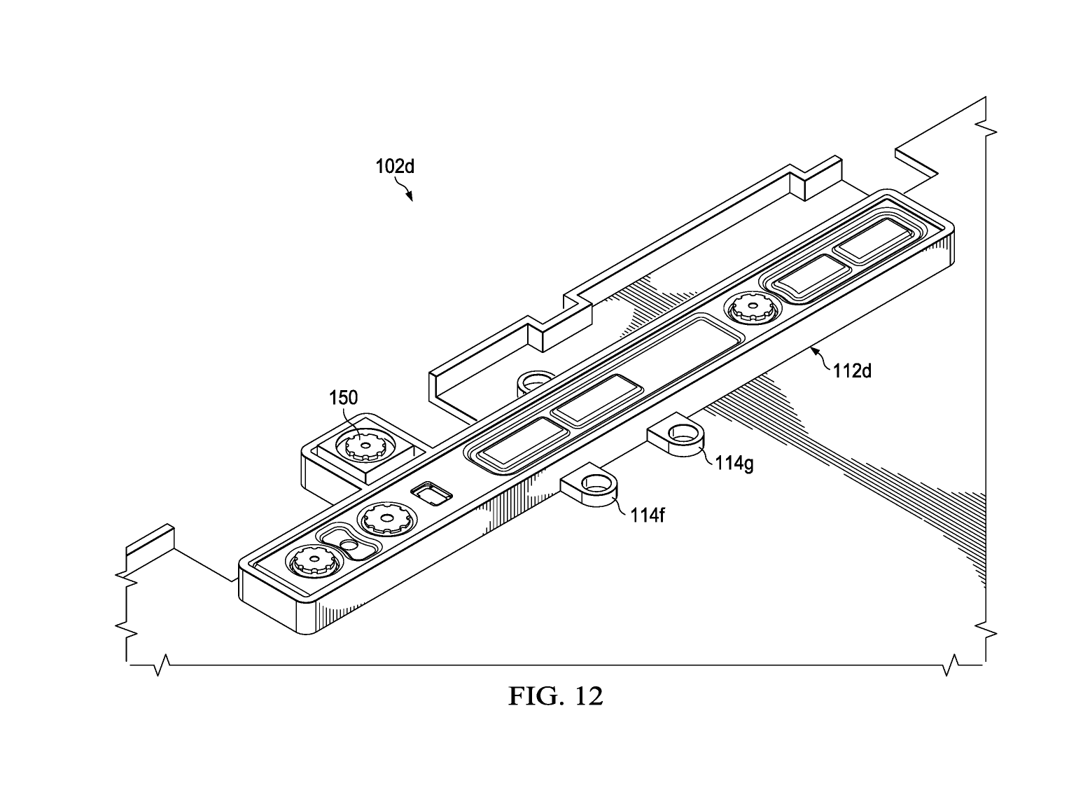

Turning to FIG. 12, FIG. 12 is a simplified orthographic view illustrating of an embodiment of structurally sensitive module 102d, in accordance with one embodiment of the present disclosure. Structurally sensitive module 102d can include RGB camera 150. FIG. 12 illustrates that various modifications and changes may be made to structurally sensitive module 102c including, but not limited to, the location of various components (e.g., RGB camera 150) of a structurally sensitive device while still providing structurally isolation of sensitive module 102d from electronic device 100.

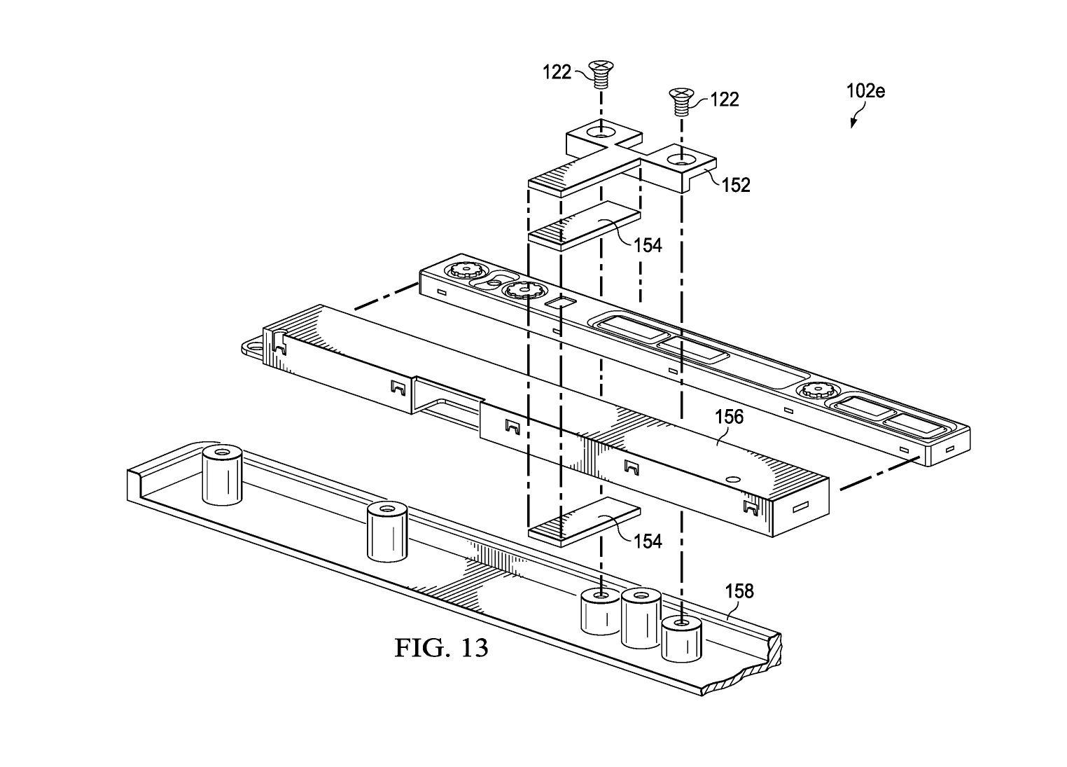

Turning to FIG. 13, FIG. 13 is a simplified orthographic view illustrating of an embodiment of structurally sensitive module 102e, in accordance with one embodiment of the present disclosure. Structurally sensitive module 102e can include clamp 152 and compliant foam 154. In an example, complaint foam 154 can be located on the top and on the bottom of structurally sensitive module 102e. Clamp 152 can then be secured to device chassis 158 using fasteners 122 and hold the mechanically sensitive component in place with compliant foam 154 above and below the mechanically sensitive component. In an example, clamp 152 can be placed near the center of the mechanically sensitive component and the contact area of compliant foam 154 may be small in order to reduce torque coupling.

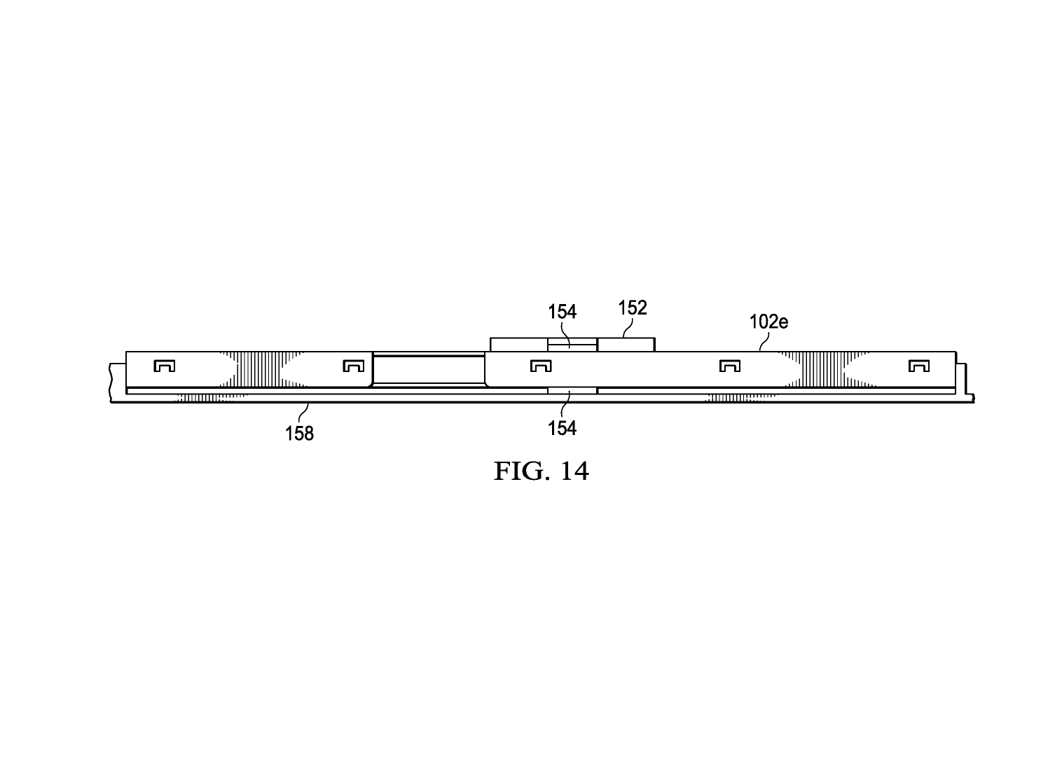

Turning to FIG. 14, FIG. 14 is a simplified plan view illustrating of an embodiment of structurally sensitive module 102e, in accordance with one embodiment of the present disclosure. Structurally sensitive module 102e can be mounted to a device chassis 158 using clamp 152 and compliant material 154. Clamp 152 and compliant material 154 can be configured to have a relatively small footprint and take up a small amount of space while still providing structurally isolation of sensitive module 102d from electronic device 100.

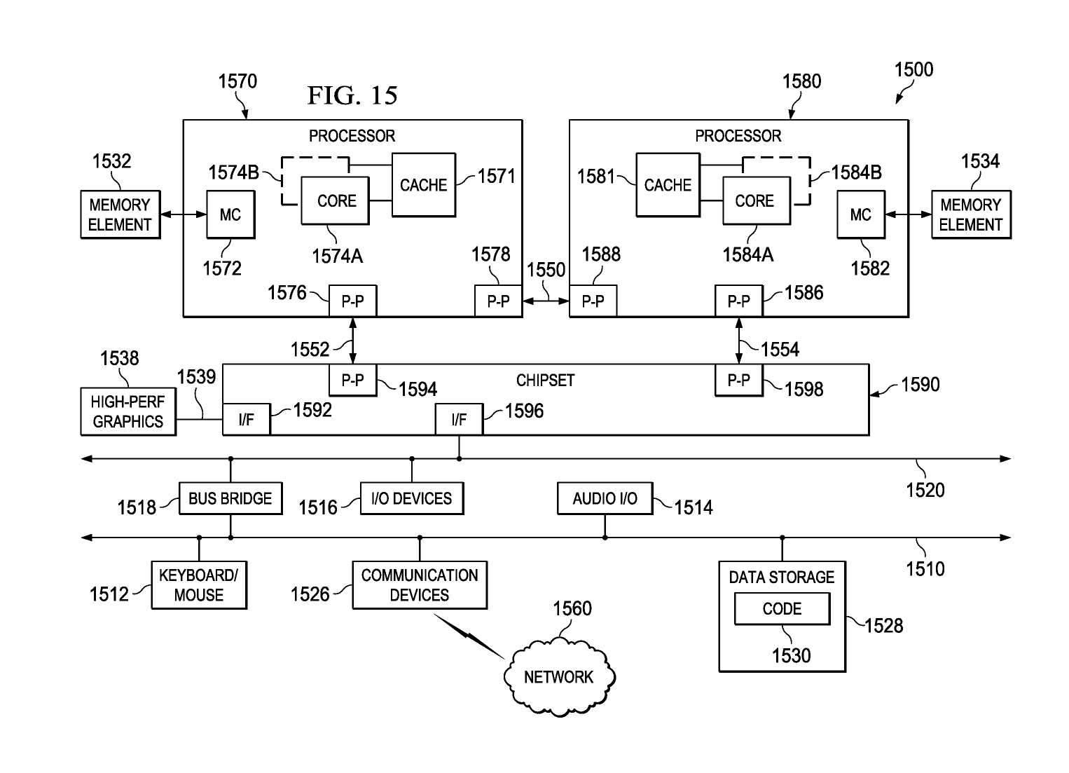

Turning to FIG. 15, FIG. 15 illustrates a computing system 1500 that is arranged in a point-to-point (PtP) configuration according to an embodiment. In particular, FIG. 15 shows a system where processors, memory, and input/output devices are interconnected by a number of point-to-point interfaces. Generally, one or more of the network elements of electronic device 100 may be configured in the same or similar manner as computing system 1500.

As illustrated in FIG. 15, system 1500 may include several processors, of which only two, processors 1570 and 1580, are shown for clarity. While two processors 1570 and 1580 are shown, it is to be understood that an embodiment of system 1500 may also include only one such processor. Processors 1570 and 1580 may each include a set of cores (i.e., processor cores 1574A and 1574B and processor cores 1584A and 1584B) to execute multiple threads of a program. The cores may be configured to execute instruction code in a manner similar to that discussed above with reference to FIGS. 2-6. Each processor 1570, 1580 may include at least one shared cache 1571, 1581. Shared caches 1571, 1581 may store data (e.g., instructions) that are utilized by one or more components of processors 1570, 1580, such as processor cores 1574 and 1584.

Processors 1570 and 1580 may also each include integrated memory controller logic (MC) 1572 and 1582 to communicate with memory elements 1532 and 1534. Memory elements 1532 and/or 1534 may store various data used by processors 1570 and 1580. In alternative embodiments, memory controller logic 1572 and 1582 may be discreet logic separate from processors 1570 and 1580.

Processors 1570 and 1580 may be any type of processor, and may exchange data via a point-to-point (PtP) interface 1550 using point-to-point interface circuits 1578 and 1588, respectively. Processors 1570 and 1580 may each exchange data with a control logic 1590 via individual point-to-point interfaces 1552 and 1554 using point-to-point interface circuits 1576, 1586, 1594, and 1598. Control logic 1590 may also exchange data with a high-performance graphics circuit 1538 via a high-performance graphics interface 1539, using an interface circuit 1592, which could be a PtP interface circuit. In alternative embodiments, any or all of the PtP links illustrated in FIG. 15 could be implemented as a multi-drop bus rather than a PtP link.

Control logic 1590 may be in communication with a bus 1520 via an interface circuit 1596. Bus 1520 may have one or more devices that communicate over it, such as a bus bridge 1518 and I/O devices 1516. Via a bus 1510, bus bridge 1518 may be in communication with other devices such as a keyboard/mouse 1512 (or other input devices such as a touch screen, trackball, etc.), communication devices 1526 (such as modems, network interface devices, or other types of communication devices that may communicate through a computer network 1560), audio I/O devices 1514, and/or a data storage device 1528. Data storage device 1528 may store code 1530, which may be executed by processors 1570 and/or 1580. In alternative embodiments, any portions of the bus architectures could be implemented with one or more PtP links.

The computer system depicted in FIG. 15 is a schematic illustration of an embodiment of a computing system that may be utilized to implement various embodiments discussed herein. It will be appreciated that various components of the system depicted in FIG. 15 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

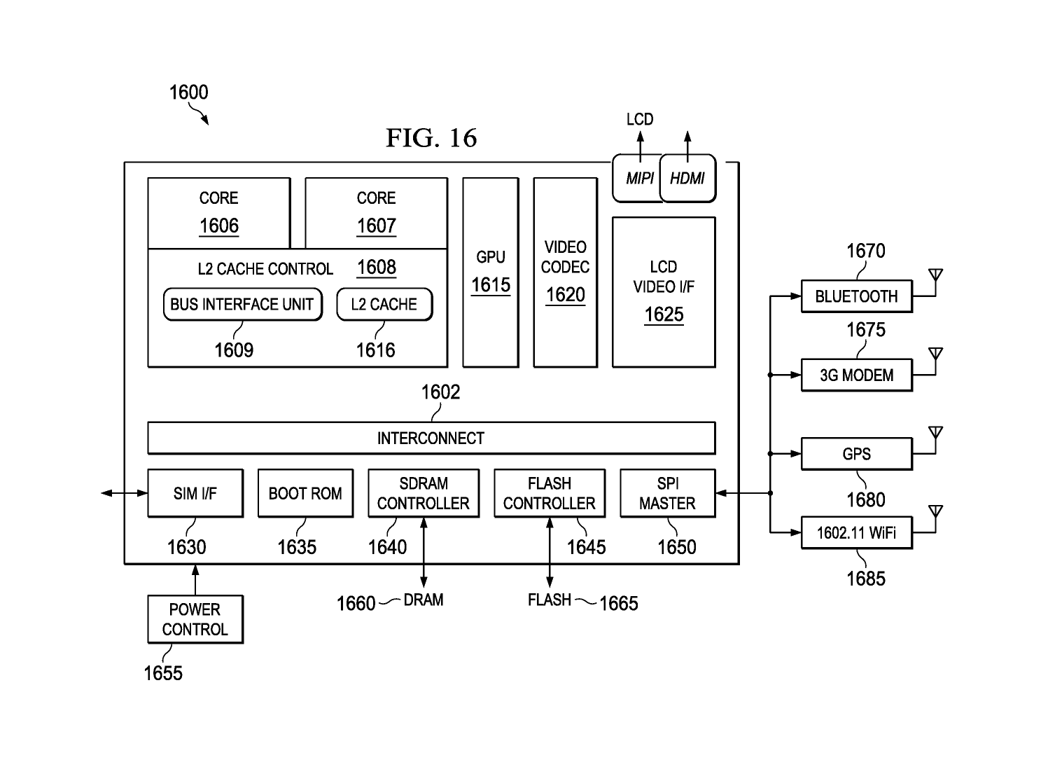

Turning to FIG. 16, FIG. 16 is a simplified block diagram associated with an example ARM ecosystem SOC 1600 of the present disclosure. At least one example implementation of the present disclosure can include the attachment for devices features discussed herein and an ARM component. For example, the example of FIG. 16 can be associated with any ARM core (e.g., A-7, A-15, etc.). Further, the architecture can be part of any type of tablet, smartphone (inclusive of Android™ phones, iPhones™, iPad™ Google Nexus™, Microsoft Surface™, personal computer, server, video processing components, laptop computer (inclusive of any type of notebook), Ultrabook™ system, any type of touch-enabled input device, etc.

In this example of FIG. 16, ARM ecosystem SOC 1600 may include multiple cores 1606-1607, an L2 cache control 1608, a bus interface unit 1609, an L2 cache 1610, a graphics processing unit (GPU) 1615, an interconnect 1602, a video codec 1620, and a liquid crystal display (LCD) I/F 1625, which may be associated with mobile industry processor interface (MIPI)/high-definition multimedia interface (HDMI) links that couple to an LCD.

ARM ecosystem SOC 1600 may also include a subscriber identity module (SIM) I/F 1630, a boot read-only memory (ROM) 1635, a synchronous dynamic random access memory (SDRAM) controller 1640, a flash controller 1645, a serial peripheral interface (SPI) master 1650, a suitable power control 1655, a dynamic RAM (DRAM) 1660, and flash 1665. In addition, one or more embodiments include one or more communication capabilities, interfaces, and features such as instances of Bluetooth™ 1670, a 3G modem 1675, a global positioning system (GPS) 1680, and an 802.11 Wi-Fi 1685.

In operation, the example of FIG. 16 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe™ Flash™ Player, Java Platform Standard Edition (Java SE), JavaFX, Linux, Microsoft Windows Embedded, Symbian and Ubuntu, etc.). In at least one embodiment, the core processor may implement an out-of-order superscalar pipeline with a coupled low-latency level-2 cache.

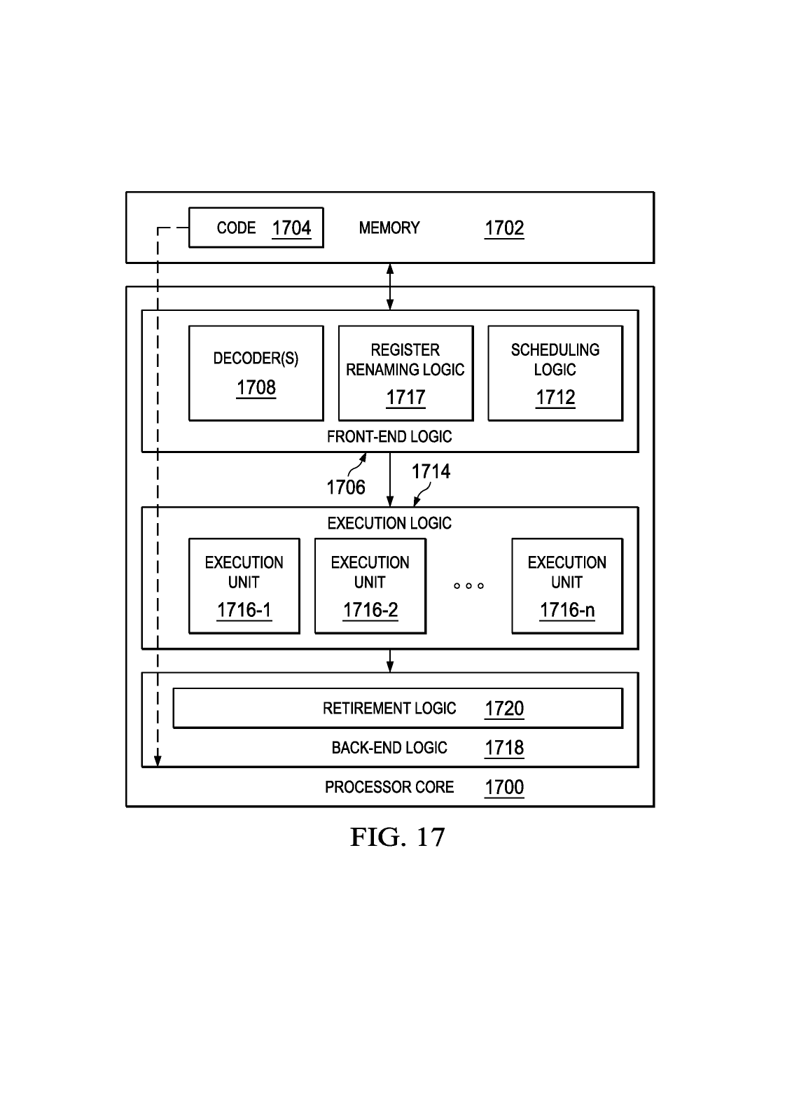

FIG. 17 illustrates a processor core 1700 according to an embodiment. Processor core 17 may be the core for any type of processor, such as a micro-processor, an embedded processor, a digital signal processor (DSP), a network processor, or other device to execute code. Although only one processor core 1700 is illustrated in FIG. 17, a processor may alternatively include more than one of the processor core 1700 illustrated in FIG. 17. For example, processor core 1700 represents an embodiment of processors cores 1574a, 1574b, 1584a, and 1584b shown and described with reference to processors 1570 and 1580 of FIG. 15. Processor core 1700 may be a single-threaded core or, for at least one embodiment, processor core 1700 may be multithreaded in that it may include more than one hardware thread context (or “logical processor”) per core.

FIG. 17 also illustrates a memory 1702 coupled to processor core 1700 in accordance with an embodiment. Memory 1702 may be any of a wide variety of memories (including various layers of memory hierarchy) as are known or otherwise available to those of skill in the art. Memory 1702 may include code 1704, which may be one or more instructions, to be executed by processor core 1700. Processor core 1700 can follow a program sequence of instructions indicated by code 1704. Each instruction enters a front-end logic 1706 and is processed by one or more decoders 1708. The decoder may generate, as its output, a micro operation such as a fixed width micro operation in a predefined format, or may generate other instructions, microinstructions, or control signals that reflect the original code instruction. Front-end logic 1706 also includes register renaming logic 1710 and scheduling logic 1712, which generally allocate resources and queue the operation corresponding to the instruction for execution.

Processor core 1700 can also include execution logic 1714 having a set of execution units 1716-1 through 1716-N. Some embodiments may include a number of execution units dedicated to specific functions or sets of functions. Other embodiments may include only one execution unit or one execution unit that can perform a particular function. Execution logic 1714 performs the operations specified by code instructions.

After completion of execution of the operations specified by the code instructions, back-end logic 1718 can retire the instructions of code 1704. In one embodiment, processor core 1700 allows out of order execution but requires in order retirement of instructions. Retirement logic 1720 may take a variety of known forms (e.g., re-order buffers or the like). In this manner, processor core 1700 is transformed during execution of code 1704, at least in terms of the output generated by the decoder, hardware registers and tables utilized by register renaming logic 1710, and any registers (not shown) modified by execution logic 1714.

Although not illustrated in FIG. 17, a processor may include other elements on a chip with processor core 1700, at least some of which were shown and described herein with reference to FIG. 15. For example, as shown in FIG. 15, a processor may include memory control logic along with processor core 1700. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that electronic device 100 and its teachings are readily scalable and can accommodate a large number of components, as well as more complicated/sophisticated arrangements and configurations. Accordingly, the examples provided should not limit the scope or inhibit the broad teachings of electronic device 100 as potentially applied to a myriad of other architectures.

It is also important to note that the operations in the diagrams illustrate only some of the possible correlating scenarios and patterns that may be executed by, or within, electronic device 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by electronic device 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although electronic device 100 has been illustrated with reference to particular elements and operations that facilitate the communication process, these elements and operations may be replaced by any suitable architecture, protocols, and/or processes that achieve the intended functionality of electronic device 100. As used herein, the term “and/or” is to include an and or an or condition. For example, A, B, and/or C would include A, B, and C; A and B; A and C; B and C; A, B, or C; A or B; A or C; B or C; and any other variations thereof.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 172 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

Example A1 is an electronic device that includes a first housing and a structurally sensitive module. The structurally sensitive module can include a structurally sensitive component and a structurally sensitive attachment. The structurally sensitive attachment includes one or more mounting tabs to structurally isolate the structurally sensitive component from the first housing.

In Example A2, the subject matter of Example A1 may optionally include where the one or more mounting tabs are secured to the first housing using a boss, a plurality of washers that includes compliant material, and a fastener.

In Example A3, the subject matter of any of the preceding ‘A’ Examples can optionally include where each of the one or more mounting tabs float on top of one of the plurality washers.

In Example A4, the subject matter of any of the preceding ‘A’ Examples can optionally include where the one or more mounting tabs are configured as cantilever mounting tabs.

In Example A5, the subject matter of any of the preceding ‘A’ Examples can optionally include where the one or more mounting tabs are located at an approximate center area of the structurally sensitive module.

In Example A6, the subject matter of any of the preceding ‘A’ Examples can optionally include where the structurally sensitive component is a 3D camera.

Example AA1 is an electronic device that includes a first housing and a structurally sensitive module. The structurally sensitive module CAN include a structurally sensitive component and a structurally sensitive attachment that includes a clamp and compliant foam.

In Example AA2, the subject matter of Example AA1 may optionally include where the compliant foam is located on a top portion of the structurally sensitive module and on a bottom portion of the structurally sensitive module.

In Example AA3, the subject matter of any of the preceding ‘AA’ Examples can optionally include where the clamp and the compliant foam are located at an approximate center area of the structurally sensitive module.

In Example AA4, the subject matter of any of the preceding ‘AA’ Examples can optionally include where the structurally sensitive component is a 3D camera.

Example M1 is a method that includes coupling a structurally sensitive component to a first housing using a structurally sensitive module. The structurally sensitive module includes the structurally sensitive component and a structurally sensitive attachment. The structurally sensitive attachment includes one or more mounting tabs to structurally isolate the structurally sensitive component from the first housing.

In Example M2, the subject matter of any of the preceding ‘M’ Examples can optionally include where the one or more mounting tabs are secured to the first housing using a boss, a plurality of washers that includes compliant material, and a fastener.

In Example M3, the subject matter of any of the preceding ‘M’ Examples can optionally include where each of the one or more mounting tabs float on top of one of the plurality washers.

In Example M4, the subject matter of any of the preceding ‘M’ Examples can optionally include where the one or more mounting tabs are located at an approximate center area of the structurally sensitive module.

In Example M5, the subject matter of any of the preceding ‘M’ Examples can optionally include where the structurally sensitive component is a 3D camera.

In Example M6, the subject matter of any of the preceding ‘M’ Examples can optionally include where the accessory includes one or more rare earth magnets to attract one or more discs of the electronic device.

An example system S1 can include an electronic device, where the electronic device includes a chassis, and a structurally sensitive module. The structurally sensitive module includes a structurally sensitive component and a structurally sensitive attachment. The structurally sensitive attachment includes one or more mounting tabs to structurally isolate the structurally sensitive component from the chassis of the first housing.

An example system S2 can include where the one or more mounting tabs are secured to the first housing using a boss, a plurality of washers that includes compliant material, and a fastener.

In Example S3, the subject matter of any of the preceding ‘S’ Examples can optionally include where each of the one or more mounting tabs float on top of one of the plurality washers.

In Example S4, the subject matter of any of the preceding ‘S’ Examples can optionally include where the one or more mounting tabs are configured as cantilever mounting tabs.

In Example S5, the subject matter of any of the preceding ‘S’ Examples can optionally include where the structurally sensitive component is a 3D camera.

1. An electronic device, comprising:
a first housing; and
a structurally sensitive module, wherein the structurally sensitive module includes:
a structurally sensitive component; and
a structurally sensitive attachment, wherein the structurally sensitive attachment includes one or more mounting tabs to structurally isolate the structurally sensitive component from the first housing.

2. The electronic device of claim 1, wherein the one or more mounting tabs are secured to the first housing using a boss, a plurality of washers that includes compliant material, and a fastener.

3. The electronic device of claim 2, wherein each of the one or more mounting tabs float on top of one of the plurality washers.

4. The electronic device of claim 1, wherein the one or more mounting tabs are configured as cantilever mounting tabs.

5. The electronic device of claim 1, wherein the one or more mounting tabs are located at an approximate center area of the structurally sensitive module.

6. The electronic device of claim 1, wherein the structurally sensitive component is a 3D camera.

7. An electronic device, comprising:
a first housing; and
a structurally sensitive module, wherein the structurally sensitive module includes:
a structurally sensitive component; and
a structurally sensitive attachment, wherein the structurally sensitive attachment includes a clamp and compliant foam.

8. The electronic device of claim 7, wherein the compliant foam is located on a top portion of the structurally sensitive module and on a bottom portion of the structurally sensitive module.

9. The electronic device of claim 7, wherein the clamp and the compliant foam are located at an approximate center area of the structurally sensitive module.

10. The electronic device of claim 7, wherein the structurally sensitive component is a 3D camera.

11. A method, comprising:
coupling a structurally sensitive component to a first housing using a structurally sensitive module, wherein the structurally sensitive module includes:
the structurally sensitive component; and
a structurally sensitive attachment, wherein the structurally sensitive attachment includes one or more mounting tabs to structurally isolate the structurally sensitive component from the first housing.

12. The method of claim 11, wherein the one or more mounting tabs are secured to the first housing using a boss, a plurality of washers that includes compliant material, and a fastener.

13. The method of claim 12, wherein each of the one or more mounting tabs float on top of one of the plurality washers.

14. The method of claim 11, wherein the one or more mounting tabs are located at an approximate center area of the structurally sensitive module.

15. The method of claim 11, wherein the structurally sensitive component is a 3D camera.

16. A system, comprising:
an electronic device, wherein the electronic device includes a chassis; and
a structurally sensitive module, wherein the structurally sensitive module includes:
a structurally sensitive component; and
a structurally sensitive attachment, wherein the structurally sensitive attachment includes one or more mounting tabs to structurally isolate the structurally sensitive component from the chassis of the electronic device.

17. The system of claim 16, wherein the one or more mounting tabs are secured to the electronic device using a boss, a plurality of washers that includes compliant material, and a fastener.

18. The system of claim 17, wherein each of the one or more mounting tabs float on top of one of the plurality washers.

19. The system of claim 16, wherein the one or more mounting tabs are configured as cantilever mounting tabs.

20. The system of claim 16, wherein the structurally sensitive component is a 3D camera.
